(19) United States
(12) Patent Application Publication
(10) Pub. No.: US 2026/0339679 A1
(43) Pub. Date: Oct. 29, 2026

(54) APPARATUS AND METHOD FOR OPTIMIZING COMPUTATION THROUGH KERNEL FUSION

(71) Applicant: DESIGNOVEL, Pohang-si Gyeongsangbukdo (KR)

(72) Inventors: Ki Young SHIN, Seoul (KR); Woo Sang SONG, Seoul (KR)

(21) Appl. No.: 19/385,009

(22) Filed: Nov. 10, 2025

(30) Foreign Application Priority Data
Apr. 24, 2025 (KR) 10-2025-0053670

(51) Int. Cl. G06F 9/445

(52) U.S. Cl. CPC G06F 9/44505

(57) ABSTRACT

Disclosed are an apparatus and a method for maximizing a computation through a kernel fusion. A computation optimization method through a kernel fusion which is carried out on a computing device including one or more processors and a memory which stores one or more programs executed by the one or more processors, includes a step of receiving input data from a central processing unit (CPU), a step of configuring a kernel parameter based on the input data, and a step of determining a kernel type based on a kernel parameter.

### CROSS-REFERENCE TO RELATED APPLICATIONS

This application claims the priority of Korean Patent Application No. 10-2025-0053670 filed on Apr. 24, 2025, in the Korean Intellectual Property Office, the disclosure of which is incorporated herein by reference.

### BACKGROUND

### Field

The present disclosure relates to a technique for relieving computation support, and more particularly, to an apparatus and a method for optimizing a computation through a kernel fusion.

### Description of the Related Art

In the computing operation of the related art, in order to perform a plurality of sub computations, a method of individually calling kernels and sequentially executing the kernels is generally used. In each computation step, a separate kernel is executed and whenever the computation is completed, a process of exchanging data with CPUs and VRAM occurs.

However, according to this method, each kernel is independently executed so that there are problems in that a latency cost between kernels is increased during the computation process and a memory transfer overhead is caused. Specifically, when a large scale computation is required, the inefficiency becomes more pronounced and it is difficult to fully utilize a parallel processing capability of GPU.

### SUMMARY

An object of the present disclosure is to provide an apparatus and a method for optimizing a computation through a kernel fusion.

According to an aspect, a computation optimization method through a kernel fusion which is carried out on a computing device including one or more processors and a memory which stores one or more programs executed by the one or more processors includes a step of receiving input data from a central processing unit (CPU); a step of configuring a kernel parameter based on the input data; and a step of determining a kernel type based on a kernel parameter.

The step of configuring a kernel parameter includes a step of determining types of input data and output data based on the input data; and a step of setting grid and block sizes based on a size of the input data.

In the step of determining types of input data and output data, a combination of additional input data configured by one or more vectors, one or more matrices, and one or more tensors which perform a predetermined computation is set in the input data.

A predetermined computation may include at least one of summation of a vector, a matrix, and a predetermined tensor and input data and concatenation of a predetermined tensor and input data.

In the step of determining types of input data and output data, the concatenation may be performed after the summation.

In the step of determining types of input data and output data, data generated by performing the predetermined computation is divided into predetermined groups to perform the normalization to generate output data.

In the step of determining types of input data and output data, it is determined whether to generate auxiliary output data which is generated by copying data generated by performing a predetermined computation according to a predetermined criterion together with output data.

In the step of determining a kernel type, any one of a first kernel type of performing a reduction operation of performing parallel-processing on a plurality of data for warp or warp and a block, among execution hierarchy structure including a thread, a warp, a block, and a grid to produce one final result and a second kernel type of performing a reduction operation on a warp, a block, and a grid may be determined.

In the step of determining a kernel type, any one of the first kernel type and the second kernel type may be determined based on the number of input data and the number of output data included in the kernel parameter.

In the step of determining a kernel type, when the number of output data is equal to or larger than the number of input data and the number of input data is larger than 1, a second kernel type may be selected.

In the step of determining a kernel type, any one of the first kernel type and the second kernel type may be determined further based on a grid dimension value which represents the number of blocks which configure the grid.

In the step of determining a kernel type, when the grid dimension value is larger than 1, the second kernel type may be selected.

In the step of determining a kernel type, when the number of output data is smaller than the number of input data or the number of input data is 1, if the grid dimension value is equal to or smaller than 1, the first kernel type may be selected.

When the number of warps included in the block is equal to or smaller than 1, the first kernel type may perform the reduction operation on the warp and when the number of warps included in the block is larger than 1, the first kernel type may perform the reduction operation on the warp and the block.

The first kernel type may perform at least one of normalization, affine transformation, and epilogue in the thread level, after performing the reduction operation.

The second kernel type performs the reduction operation on the warp, the block, and the grid, and then may reset the sizes of the grid and the block.

The second kernel type may perform at least one of normalization, affine transformation, epilogue in the thread level, after resetting the sizes of the grid and the block.

According to an aspect, a computation optimization apparatus through a kernel fusion includes one or more processors and a memory which stores one or more programs configured to be executed by one or more processors and the program is configured to receive input data from a central processing unit (CPU), configure a kernel parameter based on the input data, and determine a kernel type based on the kernel parameter.

According to an exemplary embodiment, a computation optimization apparatus through a kernel fusion may apply a kernel fusion to simultaneously perform a plurality of required computations in one kernel to individually output individual computation results and omit a process of exchanging data with a CPU and a VRAM, thereby improving a computation speed and minimizing a data movement overhead.

By doing this, a latency which is caused by calling a plurality of kernels is reduced and a parallel computation performance may be maximized. Specifically, the number of kernel transfers is reduced, thereby more efficiently utilizing a computation resource of the GPU and suppressing a waste of a memory band width.

The effects of the present disclosure are not limited to the aforementioned effects, and various other effects are included in the present specification.

### BRIEF DESCRIPTION OF THE DRAWINGS

The above and other aspects, features and other advantages of the present disclosure will be more clearly understood from following detailed description taken in conjunction with the accompanying drawings, in which:

FIG. 1 is a flowchart illustrating a computation optimization method through a kernel fusion according to an exemplary embodiment;

FIG. 2 is an exemplary view for explaining a configuring method of a kernel parameter according to an exemplary embodiment;

FIG. 3 is an exemplary embodiment for explaining a method for determining an input/output data type according to an exemplary embodiment;

FIG. 4 is an exemplary view for explaining group normalization according to an example;

FIG. 5 is an exemplary view for explaining a method of determining grid and block sizes according to an exemplary embodiment;

FIG. 6 is an exemplary view for explaining a method for determining a kernel type according to an exemplary embodiment;

FIG. 7 is an exemplary view for explaining an operation method for a first kernel type according to an exemplary embodiment;

FIG. 8 is an exemplary view for explaining an operation method for a second kernel type according to an exemplary embodiment; and

FIG. 9 is a diagram of a configuration of a computation optimization apparatus through a kernel fusion according to an exemplary embodiment.

### DETAILED DESCRIPTION OF THE EMBODIMENT

Hereinafter, an exemplary embodiment of the present disclosure will be described in detail with reference to the accompanying drawings. In the description of the present disclosure, a detailed description of known configurations or functions incorporated herein will be omitted when it is determined that the detailed description may make the subject matter of the present disclosure unclear. Further, the terms to be described below are defined considering the functions in the present invention and may vary depending on the intention or usual practice of a user or operator. Accordingly, the terms need to be defined based on details throughout this specification.

Hereinafter, exemplary embodiments of a computation optimization apparatus through a kernel fusion and a method thereof will be described in detail with reference to drawings.

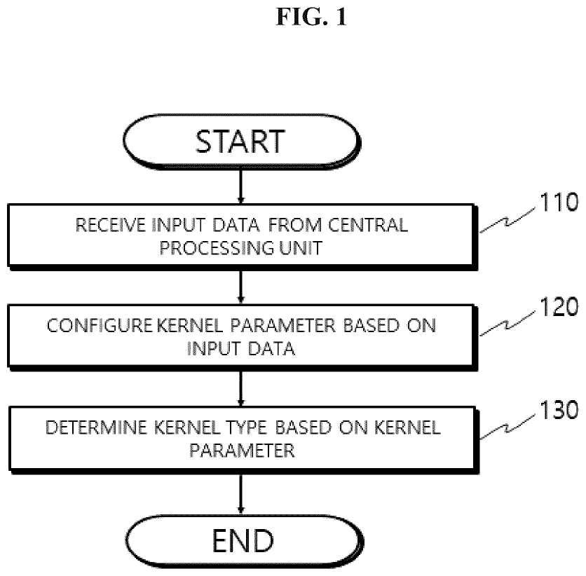

FIG. 1 is a flowchart illustrating a computation optimization method through a kernel fusion according to an exemplary embodiment.

In a parallel processing method of a graphic processing unit (GPU) of the related art, in order to perform a plurality of sub computations, a plurality of kernels is individually called and is sequentially executed to perform the computation. During this process, it was necessary to individually exchange a computation result of each kernel with a CPU or a VRAM, which may cause a memory transfer cost and an overhead (latency) due to switching between kernel executions. This method reduces a computation speed and has a limitation in that when a large scale computation is performed, a GPU resource is not efficiently utilized.

For example, the computation optimization apparatus through a kernel fusion uses a fused kernel which allows a plurality of computations to be simultaneously performed in one kernel so that individual computation results are not separately output, but all computations are processed in one kernel, thereby removing unnecessary data transfer with the CPU and the VRAM. By doing this, the overhead due to the kernel transfer is reduced to minimize a computation latency.

For example, the computation optimization apparatus through a kernel fusion reduces the number of kernel calls to improve the entire computation speed and minimizes a memory transfer process to save a data transfer cost. Further, one kernel performs a composite computation to maximize a parallel processing performance and improves performances of various GPU based computations, such as deep learning, graphic rendering, and scientific computation.

According to an exemplary embodiment, the computation optimization apparatus through a kernel fusion receives input data from a central processing unit (CPU) in step 110 and may configure a kernel parameter based on input data.

According to an exemplary embodiment, the computation optimization apparatus through a kernel fusion determines a type of input data and output data based on input data through a process of configuring a kernel parameter in step 121 and may set a size of a grid and a block based on a size of input data in step 123.

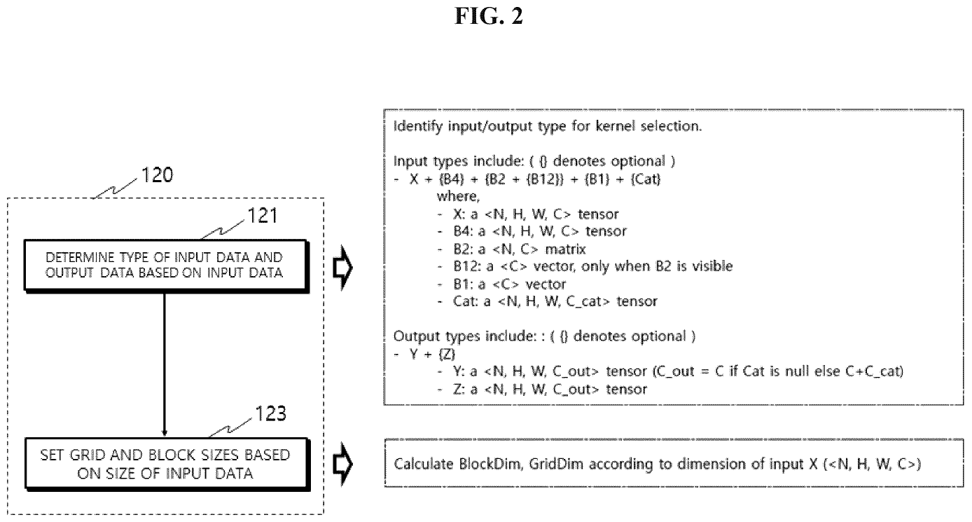

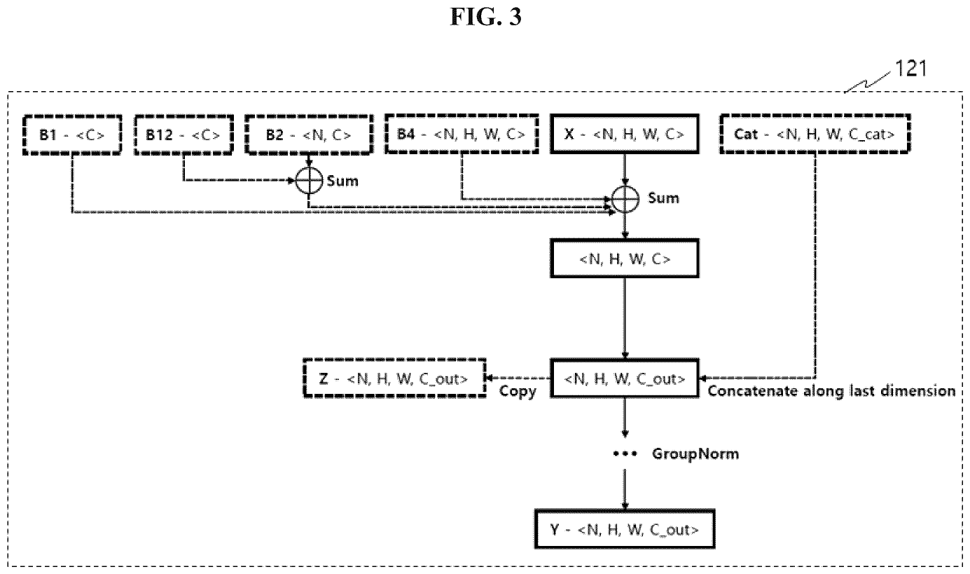

Referring to FIGS. 2 and 3, the computation optimization apparatus through a kernel fusion may determine an optimal kernel parameter according to a combination of auxiliary input data, such as input data X(<N, H, W, C>) and auxiliary input data B4, B2, B12, B1, and Cat which may be optionally added, before executing a kernel.

According to an example, the computation optimization apparatus through a kernel fusion may determine a type of input data and output data by setting a combination of additional input data configured by one or more vectors which performs the computation, one or more metrics, and one or more tensors to input data.

Referring to FIG. 2, the computation optimization apparatus through a kernel fusion may configure an optimal computation flow by setting a combination of additional input data (vector, matrix, tensor) which performs a specific computation to the input data X(<N, H, W, C>). Here, X is a four-dimensional tensor which is basic computation target and during the computation process, is combined with additional data, such as vectors B1, B12, a matrix B2, or tensors B4, Cat, to optimize the computation.

The configuration of the additional input data may vary depending on a computation requirement and each data may perform a specific role. For example, the vectors B1 and B12 include a scalar value in the unit of channels to serve to correct the computation and the matrix B2 may be used to perform batch-wise (N) or channel-wise (C) normalization. Further, the tensors B4 and Cat include data having the same dimension as X and may be utilized for data correction or feature augmentation. As described above, the computation optimization apparatus through a kernel fusion may determine how input data X is deformed and how output data is configured by setting a combination of various additional input data.

According to an exemplary embodiment, a predetermined computation may include at least one of a computation of summing a vector, a matrix, and a predetermined tensor and input data and a computation of concatenating a predetermined tensor and input data. For example, the computation optimization apparatus through a kernel fusion performs a computation on input data by utilizing vector, matrix, and tensor and such computation includes at least one of “summation” and “concatenation”. By doing this, a structure of input data is deformed and corrected to generate an optimal computation result.

According to an example, the summation performs the computation by summing input data X(<N, H, W, C>) and additional input data B1, B12, B2, and B4 element-wisely or channel-wisely. Referring to FIG. 3, a vector such as B1(<C>) or B12(<C>) may be expanded to each channel of X according to an broadcasting manner to be summed and B2(<N, C>) may be used to perform channel-wise computation. Further, B4(<N, H, W, C>) has the same dimension as X so that the element-wise summation is performed to correct the data. A mean and a variance are adjusted by the summation during the normalization process or a specific correction value is added to increase the accuracy of the computation.

According an example, the concatenation is a method of connecting and expanding the input data X(<N, H, W, C>) and additional input data Cat(<N, H, W, C_cat>) in a last dimension (channel dimension). When this computation is performed, a C_cat channel is added to the existing C channel and as a result, output data has a form of Y(<N, H, W, C+C_cat>). The concatenation may be useful to expand a feature of input data or combine different data sources to one tensor. For example, it may be applied when a plurality of filter results is coupled to one tensor or additional auxiliary information is included.

By doing this, the computation optimization apparatus through a kernel fusion sets a combination of a vector, a matrix, and a tensor in accordance with various computation conditions and automatically selects an optimal computation method to maximize a performance of the GPU. Further, computations which are individually executed in the existing method are simultaneously performed in one kernel to reduce the number of kernel calls, minimize a memory transfer cost, and maximize the computation speed.

According to an exemplary embodiment, the computation optimization apparatus through a kernel fusion performs the concatenation after performing the summation. Referring to FIG. 3, the computation optimization apparatus through a kernel fusion may perform the summation by utilizing additional input data, such as vectors B1 and B12, a matrix B2, and a tensor B4, with respect to the input data X(<N, H, W, C>). For example, a vector, such as B1(<C>) or B12(<C>), is broadcasted in accordance with the channel dimension of X to perform element-wise sum and B2(<N, C>) may perform channel-wise correction. Further, B4(<N, H, W, C>) has the same dimension as X so that the element-wise summation is performed to perform normalization and data correction. By this process, the input data X is transformed to a computed new tensor X'.

Next, the computation optimization apparatus through a kernel fusion performs the concatenation on data X′(<N, H, W, C>) on which the summation is completed to concatenate the additional input data Cat(<N, H, W, C_cat>). That is, Cat is concatenated in a last dimension (Channel dimension) to generate a C+C_cat type of expanded tensor Y(<N, H, W, C+C_cat>). During this process, the input data is subject to the normalization and correction operation, and then is transformed to include an additional feature, thereby maintaining an optimal computation structure in the GPU.

According to an exemplary embodiment, the computation optimization apparatus through a kernel fusion divides data generated by performing a predetermined computation into predetermined groups to perform the normalization to generate output data. The computation optimization apparatus through a kernel fusion performs a specific computation (summation, concatenation, etc.), and then divides the generated data into predetermined groups to perform the normalization, thereby generating optimized output data. By doing this, individual computation steps are reduced and the computation efficiency of the GPU may be maximized.

For example, the group normalization GN is an approach of dividing channels of input data into num_groups groups to independently normalize each group and the total number of channels num_channels should be a multiple of num_groups. By doing this, a mean and a variance are calculated in each group and the same statistical value is used to perform the normalization. For example, when the input data is X(<N, H, W, C>), num_groups is 4, and num_channels is 16, in each group, four (C/num_groups=4) channels are included and the normalization is performed for each group.

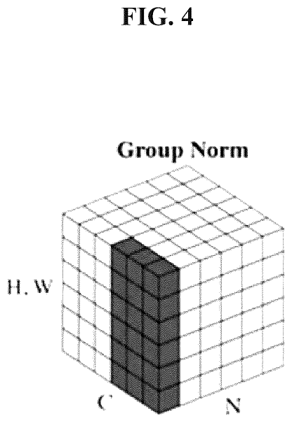

FIG. 4 visualizes an operation method of group normalization (GN) and illustrates a process of performing the normalization by forming a specific group with respect to a channel (C) dimension in an input data tensor X(<N, H, W, C>). A part highlighted with blue in FIG. 4 represents one group and after independently calculating a mean and a variance for the channels in the same group, the normalization is applied.

That is, the computation optimization apparatus applying a kernel fusion sequentially processes the summation, the concatenation, and group normalization in one kernel, rather than the individual normalization operation, to minimize the computation latency. Further, the memory transfer between the GPU and the CPU is reduced and additional data transfer required for the normalization process is removed to perform efficient computation.

According to the exemplary embodiment, the computation optimization apparatus applying a kernel fusion may determine whether to generate auxiliary output data which is generated by copying data generated by performing a predetermined computation according to a predetermined criterion together with output data. For example, the computation optimization apparatus applying a kernel fusion may determine whether it is necessary to reuse the computed data for a subsequent computation or whether to hold separate auxiliary output data in consideration a memory usage efficiency.

According to an example, the auxiliary output data Z may be used for an additional epilogue process and for example, when parallel processing with other computation is required, a copy of the data is maintained to suppress computation bottleneck. Further, when in the GPU, a specific computation is repeatedly applied, auxiliary data is generated, instead of directly correcting the output data, to suppress the memory conflict and optimize a computation efficiency.

For example, whether to generate auxiliary output data may be dynamically determined based on a purpose of the computation, a memory usage amount, and necessity of subsequent computation. For example, the optimization is performed such that when the additional computation is not necessary, Z is not generated, but only Y is maintained to minimize the memory usage and in contrast, when deformation of data is expected during a multiple computation process, Z is generated to main original data.

For example, the computation optimization apparatus through a kernel fusion may set sizes of a grid and a block based on a size of input data in step 123.

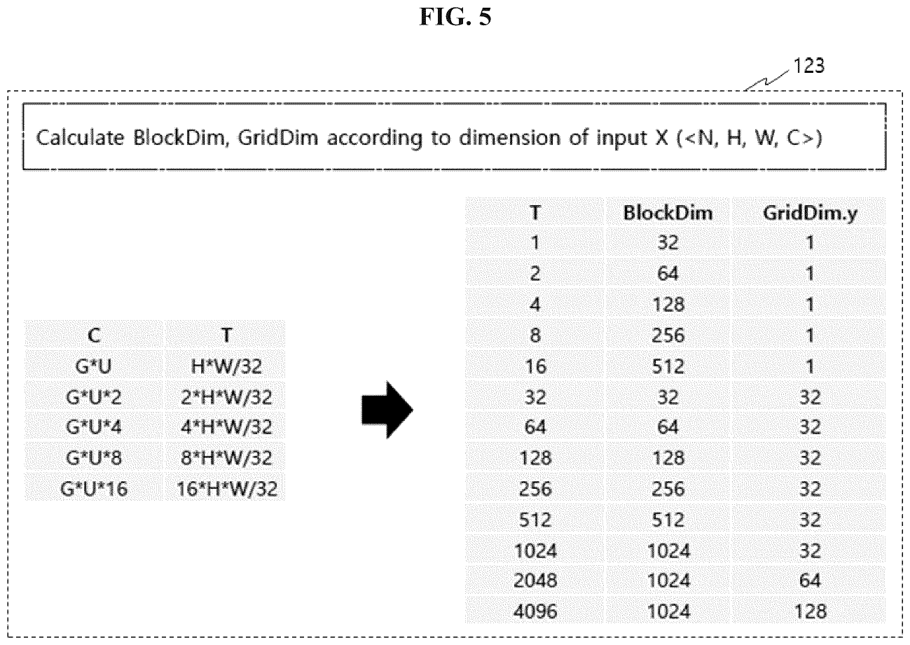

The computation optimization apparatus through a kernel fusion may dynamically set the sizes of grid and block based on the size (X: <N, H, W, C>) of the input data. By doing this, the parallel computation performance of the GPU is maximized and the computation latency may be minimized. Referring to FIG. 5, the computation optimization apparatus through a kernel fusion calculates a total number T of threads according to the number C of channels and a space size (H, W) of the input data and may set BlockDim (block size) and GridDim (grid size) based on the total number of threads. For example, the total number T of threads may be dynamically determined based on the following Equation.

T=G*U*(H*W)/32 Equation 1

Here, G is the number of groups, U is the number of loop unrolling and H and W are space dimensions of input data. The total number of threads to be executed may be calculated according to the size of the input data, based on Equation 1.

For example, the computation optimization apparatus through a kernel fusion may determine BlockDim (block size) and GridDim (grid size) based on the calculated T. The block size (BlockDim) is set in consideration of maximum thread limitation (up to 1024) of CUDA and the grid size GridDim may be utilized as an element for determining the number of blocks responsible for the overall computation. As illustrated in FIG. 5, as T is increased, BlockDim is expanded from 32 to 1024 and GridDim.y is gradually increased to form an optimal parallel computation structure.

As described above, the computation optimization apparatus through a kernel fusion dynamically adjusts the sizes of Grid and Block in accordance with the size of the input data to maximize the computation performance of the GPU and reduce unnecessary computational overhead, and minimize a memory transfer latency.

According to an exemplary embodiment, the computation optimization apparatus through a kernel fusion may determine a kernel type based on a kernel parameter in step 130.

For example, the kernel type may include any one of a first kernel type of performing a reduction operation of performing parallel-processing on a plurality of data for warp or warp and a block, among execution hierarchy structure including a thread, a warp, a block, and a grid and a second kernel type of performing a reduction operation on a warp, a block, and a grid.

According to an exemplary embodiment, the computation optimization apparatus through a kernel fusion may determine any one of the first kernel type and the second kernel type, based on the number of input data and the number of output data included in the kernel parameter in step 131. For example, when the number of output data is smaller than the number of input data, or the number of input data is 1, a grid dimension value is equal to or smaller than 1, the computation optimization apparatus through a kernel fusion may select the first kernel type.

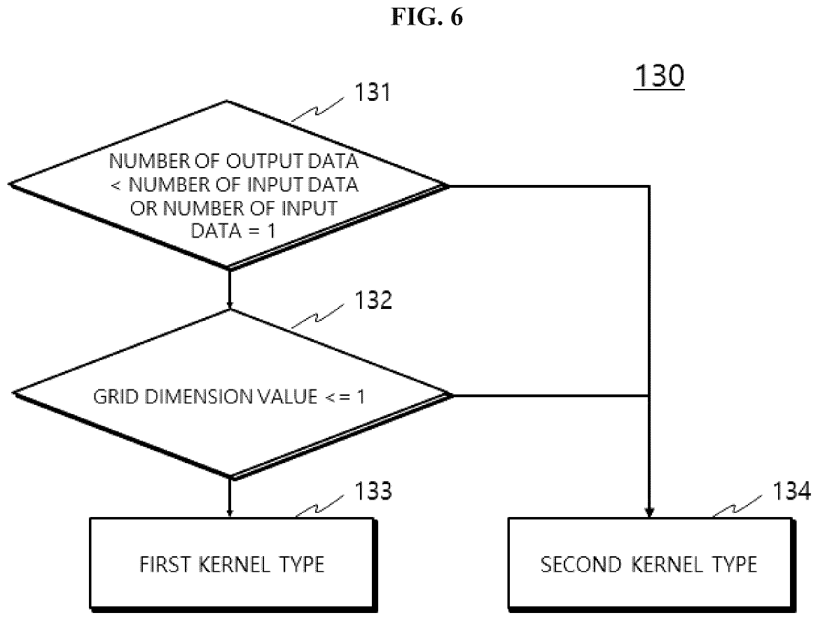

Referring to FIG. 6, when the number of output data is smaller than the number of input data (Output<Input) or the number of input data is 1 (Input=1), the computation optimization apparatus through a kernel fusion selects the first kernel type in step 133. In contrast, when the number of output data is equal to or larger than the number of input data (Output≥Input) and the number of input data is larger than 1 (Input>1), the second kernel type 134 is selected.

According to an exemplary embodiment, the computation optimization apparatus through a kernel fusion may determine any one of the first kernel type and the second kernel type further based on the grid dimension value which represents the number of blocks which configure the grid in step 132.

For example, the computation optimization apparatus through a kernel fusion may determine the first kernel type or the second kernel type based on not only the number of input and output data, but also a grid dimension value representing the number of blocks which configure the grid in step 132. For example, the computation optimization apparatus through a kernel fusion considers the grid dimension value as an additional determination criterion when the number of output data is smaller than the number of input data (Output<Input) and the number of input data is 1 (Input=1). If the grid dimension value is equal to or smaller than 1 (GridDim≤1), the first kernel type 133 may be selected. By doing this, when a relatively simple computation is performed, unnecessary block extension is suppressed and optimal computation performance may be maintained.

In contrast, even though the number of output data is smaller than the number of input data (Output<Input) or the number of input data is 1 (Input=1), when the grid dimension value is larger than 1 (GridDim>1), the computation optimization apparatus through a kernel fusion may select the second kernel type 134.

According to the exemplary embodiment, when the number of warps included in the block is equal to or smaller than 1, the first kernel type may perform the reduction operation on the warp and when the number of warps included in the block is larger than 1, the first kernel type may perform the reduction operation on the warp and the block.

According to an example, the first kernel type may perform different reduction operations according to the number of warps included in the block. That is, when the number of warps in the block is equal to or smaller than 1, the reduction operation is performed only in the warp level and when the number of warps in the block is larger than 1, the reduction operation may be performed not only in the warp level, but also in the block level.

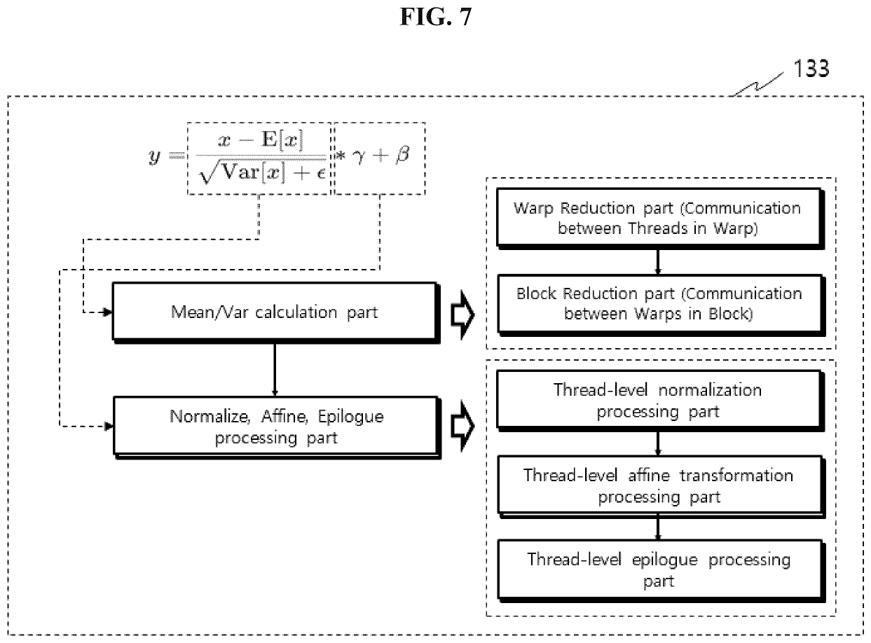

Referring to FIG. 7, during the Mean/Var (mean/variance) calculating process, the warp reduction operation and the block reduction operation may be performed step by step. First, in the warp reduction operation step, individual threads share the data in the same warp to perform the reduction operation. During this process, Register and L1 Cache are used and the data is exchanged therebetween.

Next, an additional computation is performed according to the number of warps included in the block. When the number of warps included in the block is equal to or smaller than 1, additional block reduction operation is not necessary and the computation is completed only with the warp reduction operation. However, when the number of warps in the block is larger than 1, a block reduction operation which additionally merges the reduction operation result performed in each warp in the block level is performed. At this time, not only Registers and L1 cache, but also L2 cache is utilized to exchange data between warps.

As seen in FIG. 7, the block reduction operation is selectively performed and the grid reduction operation (reduction operation in the entire grid) is not applied. By doing this, a calculation overhead which is not necessary in the GPU computation is reduced and the computation efficiency may be maximized. That is, the first kernel type performs only the warp-level reduction operation based on the number of warps in the block or performs an additional reduction operation in warp and block levels, thereby efficiently utilizing the memory hierarchy to achieve the computation optimization.

According to the exemplary embodiment, the first kernel type may perform at least one of normalization, affine transformation, and epilogue in the thread level, after performing the reduction operation. According to an example, the first kernel type may execute at least one of normalization, affine transformation, and epilogue in the thread level, after performing the reduction operation.

For example, after calculating the mean and the variance of the input data by means of the reduction operation, the normalization may be performed in the thread level. Next, in the affine transformation step, γ (scaling) and â (shift) parameters are applied to transform normalized data. Finally, in the Epilogue step, activation functions, such as ReLU or SiLU or additional post-processing computation may be performed.

For example, each computation process utilizes Registers and Li Cache to optimize the computation performance of the GPU and minimizes the data transfer to improve the computation speed. By doing this, the number of kernel calls is reduced and the overall computation latency may be minimized and more efficiency computation is performed in a deep learning and high performance computing environment.

According to an exemplary embodiment, the second kernel type performs the reduction operation on the warp, the block, and the grid, and then may reset the sizes of the grid and the block. For example, according to the second kernel type, a Mean/Var calculation part primarily calculates the mean and the variance for the input data and during this process, a reduction operation in the warp, block, and grid levels is performed.

For example, in the warp reduction operation step, the mean and the variance are calculated while sharing data between individual threads in the warp. During this process, Register and L1 Cache are utilized and the data is exchanged therebetween. In the block reduction operation step, communication between a plurality of warps in the block is performed to proceed a final block-level reduction operation. At this time, not only Registers, L1 Cache, but also L2 Cache is used and the data is exchanged between warps. In the reduction operation step, communication between a plurality of blocks in the grid is performed to perform the final grid-level reduction operation. During this process, not only Registers, L1/L2 Caches, but also VRAM is utilized and data computed in a plurality of blocks is finally merged.

For example, after performing the reduction operation in the warp, block, and grid levels, the second kernel type may reset grid and block sizes for optimal parallel computation. By doing this, the computation efficiency is increased and the resource utilization while executing the kernel may be optimized.

According to an example, after calculating the mean/var (mean·variance) in the second kernel type, the computation optimization apparatus through a kernel fusion performs the reduction operation in the warp, block, and grid levels and secondarily reconfigures Thread layout (BlockDim, GridDim) based thereon to set a kernel parameter. By doing this, the computation efficiency is maximized and an optimal kernel execution environment may be formed.

First, the computation optimization apparatus through a kernel fusion performs a primary computation on the input data in the Mean/Var calculation part to perform a reduction operation during the process of calculating the mean and the variance. At this time, the data reduction is performed in the warp, block, and grid levels and the calculated mean and variance are used in the subsequent normalization process.

Next, a secondary kernel parameter configuring part, a process of reconfiguring a thread layout to ensure the optimal computation performance is performed. That is, after analyzing the existing thread layout (BlockDim, GridDIm), a new block and grid size is dynamically set in accordance with the current computation status. This is an optimization process of uniformly distributing a computation load, reducing the computation overhead, and more efficiently utilizing the resource of the GPU.

The reason for reconfiguring the thread layout to reset the kernel parameter is that the initially set Grid/Block size may fail to show the optimal performance while proceeding the specific computation. Accordingly, when the block and grid sizes are newly adjusted by analyzing the computation load after calculating Mean/Var, the parallelism of the GPU computation is maximized and the data transfer and the computation latency may be minimized. Specifically, when large-scale data processing or multi-step computation is required, the thread layout is reconfigured to more efficiently execute the subsequent computation and if necessary, specific computations may be additionally parallelized.

According to the exemplary embodiment, the second kernel type may perform at least one of normalization, affine transformation, and epilogue in the thread level, after resetting the sizes of the grid and the block. For example, the computation optimization apparatus through a kernel fusion may perform at least one of normalization, affine transformation, and epilogue in the thread level after resetting the grid and block sizes, to maximize the computation efficiency by means of the second kernel type.

For example, after resetting the grid and block sizes, the computation optimization apparatus through a kernel fusion performs the computation in the thread level, and executes at least one of normalization, affine transformation, and epilogue. For example, a thread-level normalization part performs the normalization based on the mean and the variance by utilizing Registers and L1 cache.

A thread-level affine transformation processing part applies γ (scaling) and â (shift) parameters to transform the normalized data. If necessary, a thread-level epilogue processing part applies the activation function, such as SiLU or ReLU or may perform an additional epilogue computation.

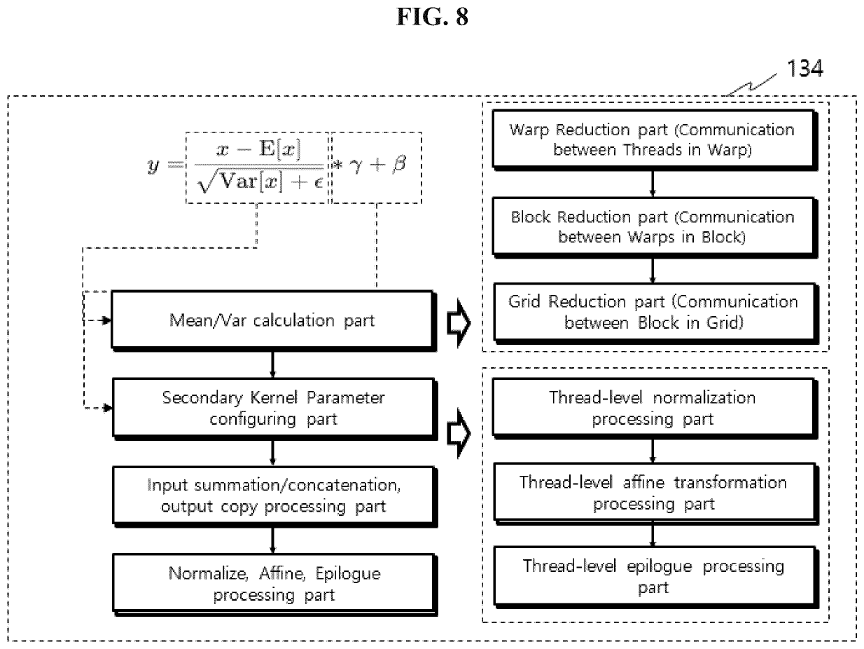

As illustrated in FIG. 8, the second kernel type optimizes the existing computation method to reset the grid and block sizes after reconfiguring the thread layout to improve the entire kernel execution performance. By doing this, the computation latency may be minimized and more efficiency performance in the large-scale data computation may be achieved.

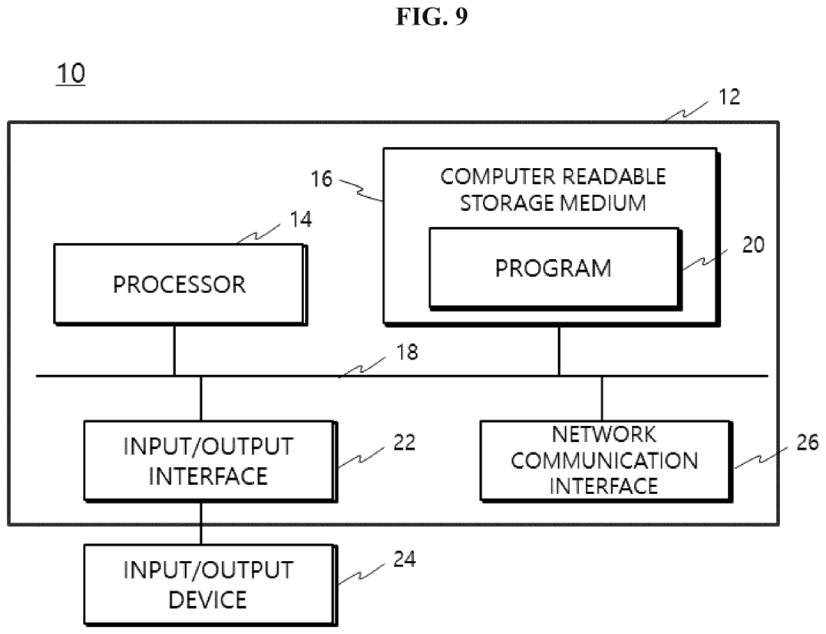

FIG. 9 is a diagram of a configuration of a computation optimization apparatus through a kernel fusion according to an exemplary embodiment.

According to an exemplary embodiment, the computation optimization apparatus through a kernel fusion includes one or more processors and a memory which stores one or more programs configured to be executed by one or more processors. At this time, the program may be configured to receive input data from the central processing unit (CPU), configure a kernel parameter based on the input data, and determine a kernel type based on the kernel parameter.

In the illustrated exemplary embodiment, each component has different function and ability other than those described below and may include additional component as well as those described below.

The illustrated computing environment 10 includes a computing device 12. In one exemplary embodiment, the computing device 12 may be a computation optimization apparatus through a kernel fusion.

The computing device 12 includes at least one processor 14, a computer readable storage medium 16, and a communication bus 18. The processor 14 may cause the computing device 12 to operate according to the above-mentioned exemplary embodiment. For example, the processor 14 may execute one or more programs stored in the computer readable storage medium 16. One or more programs may include one or more computer executable instructions and the computer executable instruction may be configured to allow the computing device 12 to perform the operations according to the exemplary embodiments when it is executed by the processor 14.

The computer readable storage medium 16 is configured to store a computer executable instruction or program code, program data and/or other appropriate format of information. The program 20 stored in the computer readable storage medium 16 includes a set of instructions executable by the processor 14. In one exemplary embodiment, the computer readable storage medium 16 may be a memory (a volatile memory such as a random access memory, a non-volatile memory, or an appropriate combination thereof), one or more magnetic disk storage devices, optical disk storage devices, flash memory devices, and another format of storage mediums which is accessed by the computing device 12 and stores desired information, or an appropriate combination thereof.

The communication bus 18 includes a processor 14 and a computer readable storage medium 16 to interconnect various components of the computing device 12 to each other.

The computing device 12 may include one or more input/output interfaces 22 and one or more network communication interfaces 26 which provide an interface for one or more input/output devices 24. The input/output interface 22 and the network communication interface 26 are connected to the communication bus 18. The input/output device 24 may be connected to the other components of the computing device 12 by means of the input/output interface 22. The exemplary input/output device 24 may include an input device such as a pointing device (a mouse, a track pad, or the like), a keyboard, a touch input device (a touch pad, a touch screen, or the like), a voice or sound input device, various types of sensor devices and/or an image capturing device, and/or an output device such as a display device, a printer, a speaker, and/or a network card. The exemplary input/output device 24 may be included in the computing device 12 as one component which configures the computing device 12 or connected to the computing device 12 as a separate device distinguished from the computing device 12.

An aspect of the present disclosure may also be implemented as computer-readable codes written on a computer-readable recording medium. Codes and code segments which implement the program may be easily deducted by a computer programmer in the art. The computer readable recording medium may include all kinds of recording devices in which data, which are capable of being read by a computer system, are stored. Examples of the computer-readable recording media may include ROM, RAM, CD-ROM, magnetic tape, floppy disk, optical disk and the like. Further, the computer readable recording medium is distributed in computer systems connected through a network to be written and executed with a computer readable code in a distributed manner.

For now, the present disclosure has been described with reference to the exemplary embodiments. It is understood to those skilled in the art that the present disclosure may be implemented as a modified form without departing from an essential characteristic of the present disclosure. Accordingly, the scope of the present disclosure is not limited to the above-described embodiment, but should be construed to include various embodiments within the scope equivalent to the description of the claims.

What is claimed is:

1. A computation optimization method through a kernel fusion, which is carried out on a computing device including one or more processors and a memory which stores one or more programs executed by the one or more processors, the method comprising:
a step of receiving input data from a central processing unit (CPU);
a step of configuring a kernel parameter based on the input data; and
a step of determining a kernel type based on the kernel parameter.

2. The computation optimization method through a kernel fusion according to claim 1, wherein the step of configuring a kernel parameter includes:
a step of determining types of input data and output data based on the input data; and
a step of setting grid and block sizes based on a size of the input data.

3. The computation optimization method through a kernel fusion according to claim 2, wherein in the step of determining types of input data and output data, a combination of additional input data configured by one or more vectors, one or more matrices, and one or more tensors which perform a predetermined computation is set in the input data.

4. The computation optimization method through a kernel fusion according to claim 3, wherein the predetermined computation includes at least one of summation of a vector, a matrix, and a predetermined tensor and input data and concatenation of a predetermined tensor and input data.

5. The computation optimization method through a kernel fusion according to claim 4, wherein in the step of determining types of input data and output data, the concatenation is performed after the summation.

6. The computation optimization method through a kernel fusion according to claim 5, wherein in the step of determining types of input data and output data, data generated by performing the predetermined computation is divided into predetermined groups to perform the normalization to generate output data.

7. The computation optimization method through a kernel fusion according to claim 6, wherein in the step of determining types of input data and output data, it is determined whether to generate auxiliary output data which is generated by copying data generated by performing a predetermined computation according to a predetermined criterion together with output data.

8. The computation optimization method through a kernel fusion according to claim 1, wherein in the step of determining a kernel type, any one of a first kernel type of performing a reduction operation of performing parallel-processing on a plurality of data for warp or warp and a block, among execution hierarchy structure including a thread, a warp, a block, to produce one final result, and a grid and a second kernel type of performing a reduction operation on a warp, a block, and a grid is determined.

9. The computation optimization method through a kernel fusion according to claim 8, wherein in the step of determining a kernel type, any one of the first kernel type and the second kernel type is determined based on the number of input data and the number of output data included in the kernel parameter.

10. The computation optimization method through a kernel fusion according to claim 9, wherein in the step of determining a kernel type, when the number of output data is equal to or larger than the number of input data and the number of input data is larger than 1, a second kernel type is selected.

11. The computation optimization method through a kernel fusion according to claim 10, wherein in the step of determining a kernel type, any one of the first kernel type and the second kernel type is determined further based on a grid dimension value which represents the number of blocks which configure the grid.

12. The computation optimization method through a kernel fusion according to claim 11, wherein in the step of determining a kernel type, when the grid dimension value is larger than 1, the second kernel type is selected.

13. The computation optimization method through a kernel fusion according to claim 12, wherein in the step of determining a kernel type, when the number of output data is smaller than the number of input data or the number of input data is 1, if the grid dimension value is equal to or smaller than 1, the first kernel type is selected.

14. The computation optimization method through a kernel fusion according to claim 8, wherein when the number of warps included in the block is equal to or smaller than 1, the first kernel type performs the reduction operation on the warp and when the number of warps included in the block is larger than 1, the first kernel type performs the reduction operation on the warp and the block.

15. The computation optimization method through a kernel fusion according to claim 14, wherein the first kernel type performs at least one of normalization, affine transformation, and epilogue in the thread level, after performing the reduction operation.

16. The computation optimization method through a kernel fusion according to claim 8, wherein the second kernel type performs the reduction operation on the warp, the block, and the grid, and then resets the sizes of the grid and the block.

17. The computation optimization method through a kernel fusion according to claim 16, wherein the second kernel type performs at least one of normalization, affine transformation, and epilogue in the thread level, after resetting the sizes of the grid and the block.

18. A computation optimization apparatus through a kernel fusion, comprising:
one or more processors; and
a memory which stores one or more programs configured to be executed by one or more processors,
wherein the program is configured to receive input data from a central processing unit (CPU), configure a kernel parameter based on the input data, and determine a kernel type based on the kernel parameter.
